(19) United States
(12) Patent Application Publication
(10) Pub. No.: US 2019/0137356 A1
(43) Pub. Date: May 9, 2019

(54) TESTING DEVICE AND METHOD FOR TESTING A TAMPING UNIT

(71) Applicant: Plasser & Theurer Export von Bahnbaumaschinen Gese llschaft m.b.H., Vienna (AT)

(72) Inventor: Thomas PHILIPP, Leonding (AT)

(73) Assignee: Plasser & Theurer Export von Bahnbaumaschinen Gese llschaft m.b.H., Vienna (AT)

(21) Appl. No.: 16/092,977

(22) PCT Filed: Apr. 26, 2017
(86) PCT No.: PCT/EP2017/000522

§ 371 Date: Oct. 11, 2018

(30) Foreign Application Priority Data
May 24, 2016 (AT) A 260/2016

(51) Int. Cl. G01M 13/00; G01L 5/00; G07C 3/04

(52) U.S. Cl. CPC G01M 13/00; E01B 27/16; G07C 3/04; G01L 5/0028

(57) ABSTRACT

The invention relates to a testing device (4) for testing a tamping unit (1) comprising two oppositely positioned vibratable tamping tine arms (7) which are movable towards one another, wherein the testing device (4) comprises a separate clamping device (5) in each case for clamping the two tamping tine arms (7), and wherein the two clamping devices (5) are connected to a linear drive- and measuring device (9) for recording force-path curves. A testing device (4) of this kind enables the quality testing of a tamping unit (1).

### FIELD OF TECHNOLOGY

The invention relates to a testing device and a method for testing a tamping unit comprising two oppositely positioned vibratable tamping tine arms which are movable towards one another.

### PRIOR ART

Tamping units serve for tamping a track which is supported on a ballast bed. During this, tamping tines penetrate into the ballast bed in front of and behind a sleeper, with regard to the track direction. The ballast is consolidated underneath the sleeper by means of a squeezing motion directed towards one another. During the penetration into the ballast bed and during the squeezing motion, the tamping tines are actuated with a vibratory motion in order to facilitate the shifting of the ballast.

A tamping unit in operation is subjected to great strains which necessitate regular maintenance. Usually, parts susceptible to wear are tested at prescribed maintenance intervals and replaced, if necessary. During this, it must be ensured that the tamping unit achieves the original performance characteristics after a maintenance procedure.

From GB 2 451 310 A, a method and a testing device for testing a current condition of wear of individual components are known. To that end, several sensors are arranged on a tamping unit, the measuring signals of which are compared to comparative signals of a new unit. The deviations of the signals provide information about the condition of bearings, bushings and bolts.

Also known from DE 20 2008 010 351 U1 is a device for the diagnosis of bearings at eccentric shafts of tamping units. For monitoring the bearing condition, a vibration sensor for each eccentric shaft drive is placed on the bearing block of the drive.

### SUMMARY OF THE INVENTION

It is the object of the invention to specify a testing device of the type mentioned at the beginning which enables an evaluation of the overall condition of the tamping unit. Additionally, a corresponding method is to be described.

According to the invention, this object is achieved with a testing device according to claim 1 and a method according to claim 12. Advantageous further developments of the invention become apparent from the dependent claims.

In this, the testing device comprises a separate clamping device each for clamping the two tamping tine arms, wherein the two clamping devices are connected to a linear drive- and measuring device for recording force-path curves. Such a testing device enables the quality testing of a tamping unit. Such a test is useful when developing a new tamping unit in order to be able to simulate the behaviour under various operating conditions. During this, the testing device exerts upon the tamping unit those reaction forces which in operative use are caused by the ballast bed.

Likewise in the case of tamping units already in operation, the employment of the testing device is useful in order to be able to establish the condition of the unit and the tamping quality which can be achieved under different conditions. For example, it is possible to determine with the testing device the energy content which can be introduced into a ballast bed per immersion procedure as a characteristic value for the tamping unit. Changes during repeated tests also allow early conclusions with regard to wear symptoms or malfunctions.

A further development provides that the drive- and measuring device is connected to an intelligent control. By means of said control, it is possible to change the reaction behaviour of the testing device affecting the tamping unit. In particular, different ballast bed hardnesses can be specified in this manner.

It is advantageous if a connection to a data net is provided in order to transmit data to a remote evaluation device. This enables a central evaluation of trials during a new or further development of the tamping unit or a comparative analysis of test results recorded at different times.

A simple embodiment of the invention provides that the linear drive- and measuring device comprises a linear drive which is arranged between the two clamping devices. With this arrangement it is possible to let the same reaction forces act upon both tamping tine arms.

In another embodiment, the linear drive- and measuring device comprises two linear drives, wherein a respective linear drive is arranged in each case between a clamping device and a support. In this manner, the reaction forces on each tamping tine arm can be specified separately so that different operating scenarios can be simulated.

Advantageously, the particular linear drive in each case is designed as a hydraulic cylinder. In this, even small structural sizes allow high reaction forces which are required especially for simulating hardened ballast beds. A path measuring system is integrated in the particular hydraulic cylinder for path-dependent control.

Furthermore arranged on each hydraulic cylinder are two hydraulic pressure sensors by means of which the static and dynamic forces acting on the testing device by the tamping unit can be measured. By way of the arrangement directly on the respective hydraulic cylinder, damping effects are avoided which can occur in hook-up or connecting lines. The measuring signals registered by means of pressure sensors can be used, on the one hand, for regulating the testing device and, on the other hand, for recording the force-path curves.

Alternatively, it can also be advantageous if the particular linear drive is designed as an electrical linear drive. As a consequence, a hydraulic system is not required. In addition, electric linear drives can, as a rule, be controlled in a more simple and quick-reacting manner than hydraulic drives.

Favourably, a force sensor is connected to the respective electrical linear drive. This measures continuously the static and dynamic forces acting on the linear drive by the tamping unit and delivers measuring signals for regulating or recording the force-path curves.

A simple embodiment of the respective clamping device provides that the latter is designed for clamping a free end of a tamping tine. Thus, it comprises supports for the tamping tine ends for transmitting the forces in both directions of movement. With this, tamping units can be tested without further preparations directly on a tamping machine.

Alternatively it can be useful if the clamping device in each case has a shaft which can be fastened in a tine fitting of the respective tamping tine arm. With this, even tamping units without installed tamping tines can be tested on a tamping machine or in a test stand.

The method, according to the invention, for testing a tamping unit having two oppositely positioned tamping tine arms provides that each tamping tine arm is clamped by means of a clamping device, that by means of a drive- and measuring device, variable counterforces are applied via the clamping devices to the tamping unit in operation, and that a force acting via the respective tamping tine arm on the drive- and measuring device and a path traveled by the respective tamping tine arm are measured. Thus, force-path curves can be compiled in a simple manner. These characterize the tested tamping unit and can be used for deriving further characteristic values.

The method is improved if the counterforces are regulated by means of an intelligent control. Concurrently with controlling the testing device, the measuring results are documented by means of this intelligent control.

A further improvement provides that several measuring operations are carried out with varied counterforces in order to establish a performance map. For example, via a pre-set squeezing path of the respective tamping tine arm, the resistance versus the superimposed vibration amplitude is changed in order to obtain a performance map which unambiguously characterizes the tested tamping unit.

Favourably it is intended that measuring data are transmitted to a remote evaluation device. This facilitates a central evaluation and documentation of the measuring results.

### BRIEF DESCRIPTION OF THE DRAWINGS

The invention will be described by way of example with reference to the attached Figures. There is shown in schematic representation in:

FIG. 1 a testing device having a linear drive,

FIG. 2 a testing device having two linear drives.

### DESCRIPTION OF EMBODIMENTS

In the Figures, a lower portion of a tamping unit 1 to be tested is shown. Two tamping tine arms 3 are rotatably mounted in an assembly frame 2. As a rule, a squeezing motion of the respective tamping tine arm 3 takes place by means of a squeezing cylinder, not shown, which moves the upper leg of the tamping tine arm 3 outward. This squeezing motion is superimposed by a vibratory motion which either is applied by a separate vibration drive or produced by the squeezing cylinder itself.

As a vibration drive, an eccentric drive has proven itself in which a rotatingly driven eccentric is connected to an oscillating mass. The respective squeezing cylinder is connected to the vibration drive for transmitting the vibratory motion to the associated tamping tine arm 3.

Another design provides for vibration production by means of imbalance masses. The aim of the vibratory motions is a high compaction of the ballast underneath a sleeper in order to ensure a homogenous and stable support of the same.

Every design of a tamping unit 1 effects characteristic functional features which can be detected by means of the present testing device 4 and the corresponding method. For example, a stable vibration amplitude can be achieved with an eccentric drive, whereas a vibration production by means of hydraulic cylinders is susceptible to vibration drops in the case of increased ballast resistance.

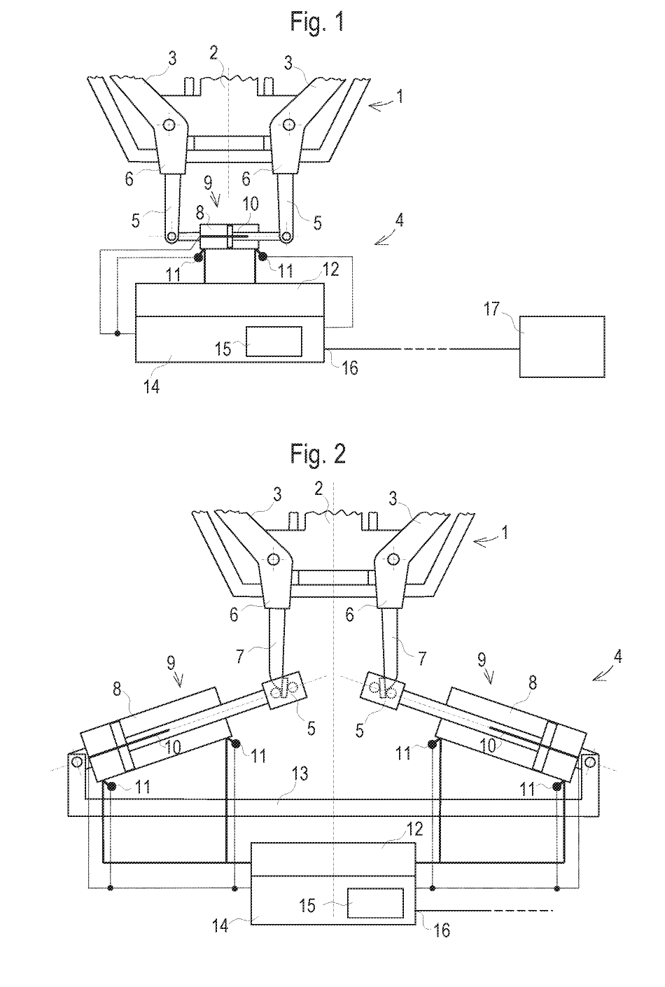

At the start of a testing procedure, the testing device 4 is connected to the tamping unit 1. To that end, the testing device 4 comprises two clamping devices 5 which, for example—as shown in FIG. 1—are inserted directly in tamping tine fittings 6 of the tamping unit 1. In FIG. 2, the clamping devices 5 are applied to tamping tines 7 mounted in the tamping unit 1. In any case, a clearance-free transmission of the motions of the particular tamping tine arm 3 to the associated clamping device 5 must be ensured.

In a simple embodiment, a common linear drive 8 is provided which connects the clamping devices 5 of the testing device 4 to one another as a linear drive- and measuring device 9 (FIG. 1). In such a linear drive 8 those forces and motions are absorbed which are exercised by both tamping tine arms 3 relative to one another.

As a linear drive 8, for example, a hydraulic cylinder with integrated path measuring system 10 is arranged. Two pressure sensors 11 are mounted directly on the hydraulic cylinder. Additionally, a hydraulic system 12 comprises servo- and/or proportional valves for controlling the hydraulic cylinder, a protective circuitry, a hydraulic tank, a hydraulic cooler, a filter, and a pump.

In a different embodiment, the linear drive- and measuring device 9 comprises two linear drives 8 (FIG. 2). These are designed, for example, as two hydraulic cylinders connected to the hydraulic system 12. Each hydraulic cylinder is equipped with an integrated path measuring system 10 and two pressure sensors 11.

The drive- and measuring device 9 thus configured is connected to the tamping unit 1 by means of the clamping devices 5. On the other hand, the drive- and measuring device 9 is articulatedly coupled to a rigid connecting element 13. Due to this arrangement, different resistance forces can be prescribed to each tamping tine arm 3 in order to simulate an asymmetrical load of the tamping unit 1.

The hydraulic cylinders can be designed without seal in order to withstand the high strains which act upon the testing device 4 via the tamping unit 1. The hydraulic cylinders can also be designed having a separate leakage oil line in order to cool the seals by means of a specific leakage oil amount and to collect the leakage oil.

Alternatively to a hydraulic design of the linear drive- and measuring device 9, an electrical linear drive coupled to a force sensor can be useful as a linear drive 8. A load cell can be employed as a force sensor, for example.

An electrical system 14 is provided for electric supply and control of the testing device 4. Specifically, this comprises an intelligent control 15 by means of which the controlling of the testing device 4 takes place. The control 15 additionally receives the measuring signals of the respective pressure sensor 11 and the respective path measuring system 10. From this, force-path curves are determined which are stored and evaluated for documentation.

The electrical system 14 optionally encompasses a connector 16 for tying into a remote evaluation device 17. Thus, the possibility is created to transmit measuring signals by means of the control 15 to the evaluation device 17 prior to or after processing. Force-path curves can be determined and stored centrally in this manner. Serving as an evaluation device 17, for example, is a computer arranged remote from the testing device 4.

When connecting to a server, it is useful to transmit to the same all of the data collected by the testing device 4. To that end, the control 15 comprises a suitable network connection. In this way, the measurement data can be called on at any time for evaluations and assessments of the tests carried out. In addition, there is the possibility to store testing parameters in the server and transmit them to the testing device 4, if needed. In this manner, a suitable testing scenario for each tamping unit 1 can be deposited at the server.

Advantageously, the electrical system 14 comprises operating elements such as a keyboard and a screen in order to enter or read out data directly at the testing device 4. For example, characteristic data of the tamping unit 1 to be tested are entered and linked to recorded measurement data.

When carrying out the method of testing the tamping unit 1, it is useful if the testing program is compiled beforehand and then runs automatically. In this, for example, different squeezing paths are passed through, wherein the resistance of the superimposed vibration amplitude is changed via the squeezing path. In this manner, a performance map is produced which unambiguously characterizes the tested tamping unit 1. Subsequent to a testing procedure, an evaluation of the tamping unit 1 takes place. This happens either directly at the testing device 4 or by means of a remote evaluation device 17.

The testing device 4 also serves for simulation of limit loads of the tamping unit 1 to be tested. By this, it is possible to test and try out new developments or new technologies already during the development phase.

In addition, the testing device 4 provides possibilities to prescribe uniform quality criteria for differently designed tamping units 1. To that end, a standardized testing sequence is specified by means of a stored testing program. For an operating license, for example, characteristic parameters which are derived from the test results must lie within prescribed ranges. Thus, it is possible to determine on the basis of test results whether a tested tamping unit 1 is suited for a certain ballast bed hardness.

In this, it is possible to also take into account special designs, such as lightweight construction units, by means of separate limit values. Lightweight units are intended for tamping a soft ballast bed and thus are to be certified only for operations of this kind. This can certainly make sense for financial reasons and is made possible by a standardized testing method.

With the stored measuring results and evaluations, a comprehensible quality certificate is present at the end of a successful test. Also, by prescribing a testing scenario, high reproducibility and thus comparability of the results are obtained.

1. A testing device (4) for testing a tamping unit (1) comprising two oppositely positioned vibratable tamping tine arms (7) which are movable towards one another, wherein the testing device (4) comprises a separate clamping device (5) each for clamping the two tamping tine arms (7), and wherein the two clamping devices (5) are connected to a linear drive- and measuring device (9) for recording force-path curves.

2. The testing device (4) according to claim 1, wherein the drive- and measuring device (9) is connected to an intelligent control (15).

3. The testing device (4) according to claim 1, wherein a connection (16) to a data net is provided in order to transmit data to a remote evaluation device (17).

4. The testing device (4) according to claim 1, wherein the linear drive- and measuring device (9) comprises a linear drive (8) which is arranged between the two clamping devices (5).

5. The testing device (4) according to claim 1, wherein the linear drive- and measuring device (9) comprises two linear drives (8), and wherein a respective linear drive (8) is arranged in each case between a clamping device (5) and a rigid connecting element (13).

6. The testing device (4) according to claim 4, wherein the linear drive (8) in each case is designed as a hydraulic cylinder.

7. The testing device (4) according to claim 6, wherein on each hydraulic cylinder two hydraulic pressure sensors (11) are arranged.

8. The testing device (4) according to claim 4, wherein the linear drive (8) in each case is designed as an electrical linear drive.

9. The testing device (4) according to claim 8, wherein a force sensor is connected to the electrical linear drive.

10. The testing device (4) according to claim 1, wherein the clamping device (5) in each case is designed for clamping a free end of a tamping tine (7).

11. The testing device (4) according to claim 1, wherein the clamping device (5) in each case has a shaft which can be fastened in a tine fitting (6) of the respective tamping tine arm (3).

12. A method for testing a tamping unit (1) having two oppositely positioned vibratable tamping tine arms (3) which are movable towards one another, wherein each tamping tine arm (3) is clamped by means of a clamping device (5), wherein by means of a drive- and measuring device (9), variable counterforces are applied via the clamping devices (5) to the tamping unit (1) in operation, and wherein a force acting via the respective tamping tine arm (3) on the drive- and measuring device (9) and a path traveled by the respective tamping tine arm (1) are measured.

13. The method according to claim 12, wherein the counterforces are regulated by means of an intelligent control (15).

14. The method according to claim 12, wherein several measuring operations are carried out with varied counterforces in order to establish a performance map.

15. The method according to claim 12, wherein measuring data are transmitted to a remote evaluation device (17).
